(19) United States
(12) Patent Application Publication
(10) Pub. No.: US 2017/0044908 A1
(43) Pub. Date: Feb. 16, 2017

(54) APPARATUS AND METHOD FOR COOLING GAS TURBINE ENGINE COMPONENTS

(71) Applicant: UNITED TECHNOLOGIES CORPORATION, FARMINGTON, CT (US)

(72) Inventors: David Richard Griffin, Tolland, CT (US); Ross Wilson, South Glastonbury, CT (US); Zachary Mott, Glastonbury, CT (US); Dwayne K. Mecklenburg, Stafford Springs, CT (US); Michael Lastrina, Manchester, CT (US)

(21) Appl. No.: 14/826,831

(22) Filed: Aug. 14, 2015

(51) Int. Cl. F01D 5/18; F02C 3/04; F02C 7/18; F01D 5/14

(52) U.S. Cl. CPC F01D 5/187; F01D 5/147; F02C 3/04; F02C 7/18; F05D 2220/32; F05D 2240/35; F05D 2260/202

(57) ABSTRACT

A rotor assembly for a gas turbine engine includes a rotor disc having an axially extending rotor disc arm and a plurality of rotor blades extending radially outwardly from the rotor disc. A cover plate is located at an axial face of the rotor disc and at least partially retained at a rotor disc arm. The rotor disc and cover plate define a rotor cavity. A plurality of airflow openings extend into the cavity to allow a flow of air into the rotor cavity to thermally condition the rotor disc and the cover plate at the rotor cavity.

### FEDERAL RESEARCH STATEMENT

This invention was made with government support under contract FA86550-09-D-2923-0021 from the United States Air Force. The government therefore may have certain rights in this invention.

### BACKGROUND

This disclosure relates to gas turbine engines, and more particularly to thermal management of turbine components of gas turbine engines.

Gas turbines hot section components, in particular turbine vanes and blades in the turbine section of the gas turbine are configured for use within particular temperature ranges. Such components often rely on cooling airflow to maintain turbine components within this particular temperature range. For example, stationary turbine vanes often have internal passages for cooling airflow to flow through, and additionally may have openings in an outer surface of the vane for cooling airflow to exit the interior of the vane structure and form a cooling film of air over the outer surface to provide the necessary thermal conditioning. Other components of the turbine often also require such thermal conditioning to reduce thermal gradients that would otherwise be present in the structure and which are generally undesirable. Thus ways to increase thermal conditioning capability in the turbine are desired.

### SUMMARY

A rotor assembly for a gas turbine engine includes a rotor disc having an axially extending rotor disc arm and a plurality of rotor blades extending radially outwardly from the rotor disc. A cover plate is located at an axial face of the rotor disc and at least partially retained at a rotor disc arm. The rotor disc and cover plate define a rotor cavity. A plurality of airflow openings extend into the cavity to allow a flow of air into the rotor cavity to thermally condition the rotor disc and the cover plate at the rotor cavity.

Additionally or alternatively, in this or other embodiments the plurality of airflow openings extend through the rotor disc arm.

Additionally or alternatively, in this or other embodiments an outer arm flange is located at the rotor arm to retain the cover plate at the rotor disc arm.

Additionally or alternatively, in this or other embodiments the rotor cavity is positioned radially outboard of the rotor disc arm.

Additionally or alternatively, in this or other embodiments the cover plate is positioned radially outboard of the rotor disc arm.

Additionally or alternatively, in this or other embodiments the plurality of rotor arm openings are one or more of circular, oval or elliptically-shaped.

Additionally or alternatively, in this or other embodiments the plurality of rotor arm openings are equally spaced around a circumference of the rotor disc arm.

Additionally or alternatively, in this or other embodiments the rotor disc arm extends in an axially upstream direction from the rotor disc.

Additionally or alternatively, in this or other embodiments the rotor is a turbine rotor.

In another embodiment, a gas turbine engine includes a combustor and a rotor positioned in fluid communication with the combustor. The rotor includes a rotor disc having an axially extending rotor disc arm and a plurality of rotor blades extending radially outwardly from the rotor disc. A cover plate is positioned at an axial face of the rotor disc and is at least partially retained at a rotor disc arm. The rotor disc and cover plate define a rotor cavity with a plurality of airflow openings extending into the cavity to allow a flow of air into the rotor cavity to thermally condition the rotor disc and the cover plate at the rotor cavity.

Additionally or alternatively, in this or other embodiments the plurality of airflow openings extend through the rotor disc arm.

Additionally or alternatively, in this or other embodiments an outer arm flange is positioned at the rotor arm to retain the cover plate at the rotor disc arm.

Additionally or alternatively, in this or other embodiments the rotor cavity is positioned radially outboard of the rotor disc arm.

Additionally or alternatively, in this or other embodiments the cover plate is positioned radially outboard of the rotor disc arm.

Additionally or alternatively, in this or other embodiments the plurality of rotor arm openings are one or more of circular, oval or elliptically-shaped.

Additionally or alternatively, in this or other embodiments the plurality of rotor arm openings are equally spaced around a circumference of the rotor disc arm.

Additionally or alternatively, in this or other embodiments the rotor disc arm extends in an axially upstream direction from the rotor disc.

Additionally or alternatively, in this or other embodiments the rotor is a turbine rotor.

In yet another embodiment, a method of thermally conditioning a rotor disc of a gas turbine engine includes positioning a cover plate at a rotor disc such that a cavity is defined between the cover plate and the rotor disc, directing an airflow into the cavity through a plurality of airflow openings in the rotor disc, and thermally conditioning the rotor disc and/or the cover plate at the cavity via a thermal energy exchange between the airflow and the rotor disc and/or the cover plate.

Additionally or alternatively, in this or other embodiments the plurality of airflow openings are positioned at an axially-extending rotor disc arm of the rotor disc.

### BRIEF DESCRIPTION OF THE DRAWINGS

The subject matter which is regarded as the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a schematic illustration of a gas turbine engine;

FIG. 2 is a partial cross-sectional view of an embodiment of a turbine disc structure; and

FIG. 3 is an axial end view of an embodiment of a turbine rotor.

### DETAILED DESCRIPTION

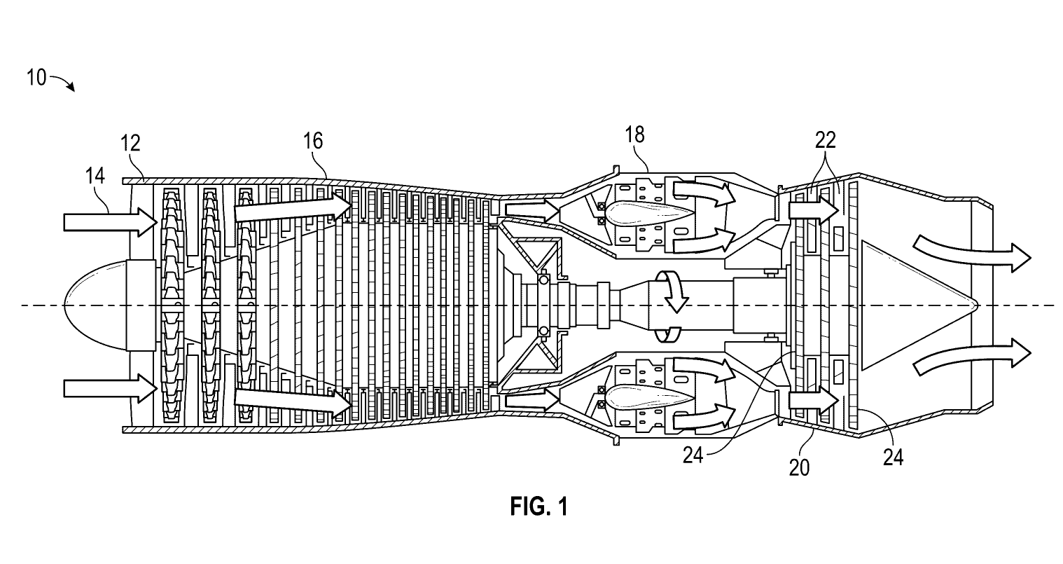

FIG. 1 is a schematic illustration of a gas turbine engine 10. The gas turbine engine generally has a fan 12 through which ambient air is propelled in the direction of arrow 14, a compressor 16 for pressurizing the air received from the fan 12 and a combustor 18 wherein the compressed air is mixed with fuel and ignited for generating combustion gases.

The gas turbine engine 10 further comprises a turbine section 20 for extracting energy from the combustion gases. Fuel is injected into the combustor 18 of the gas turbine engine 10 for mixing with the compressed air from the compressor 16 and ignition of the resultant mixture. The fan 12, compressor 16, combustor 18, and turbine 20 are typically all concentric about a common central longitudinal axis of the gas turbine engine 10.

The gas turbine engine 10 may further comprise a low pressure compressor located upstream of a high pressure compressor and a high pressure turbine located upstream of a low pressure turbine. For example, the compressor 16 may be a multi-stage compressor 16 that has a low-pressure compressor and a high-pressure compressor and the turbine 20 may be a multistage turbine 20 that has a high-pressure turbine and a low-pressure turbine. In one embodiment, the low-pressure compressor is connected to the low-pressure turbine and the high pressure compressor is connected to the high-pressure turbine.

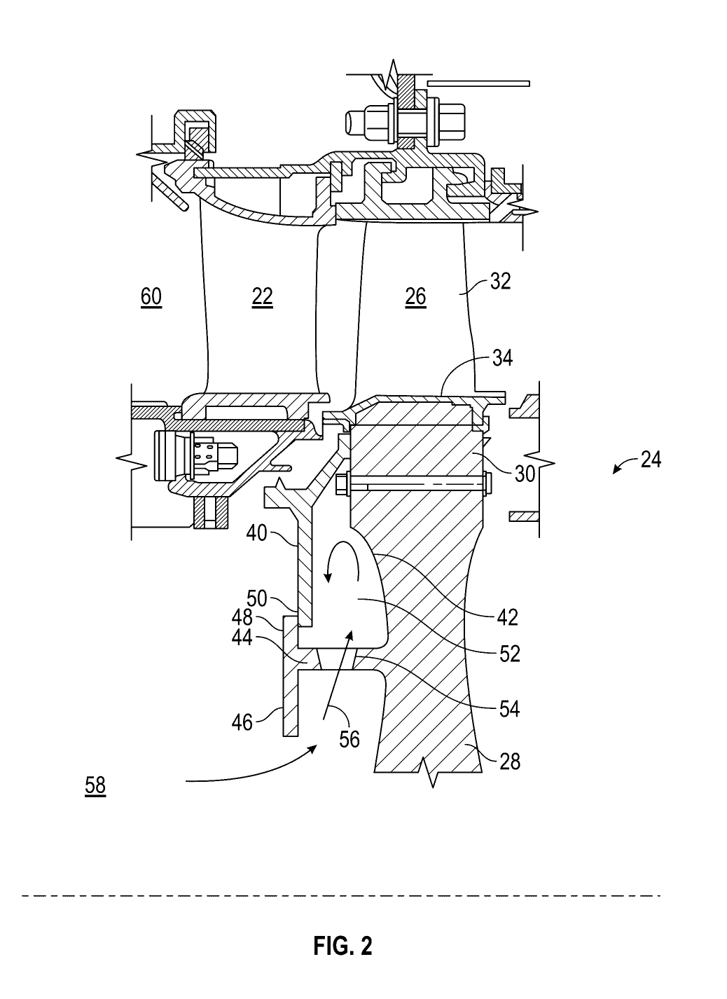

The turbine 20 includes one or more sets, or stages, of fixed turbine vanes 22 and turbine rotors 24, each turbine rotor 24 including a plurality of turbine blades 26. The turbine vanes 22 and the turbine blades 26 (shown in FIG. 2) utilize a cooling airflow to maintain the turbine components within a desired temperature range. In some embodiments, the cooling airflow may flow internal through the turbine components to cool the components internally, while in other embodiments, the cooling airflow is utilized to form a cooling film on exterior surfaces of the components.

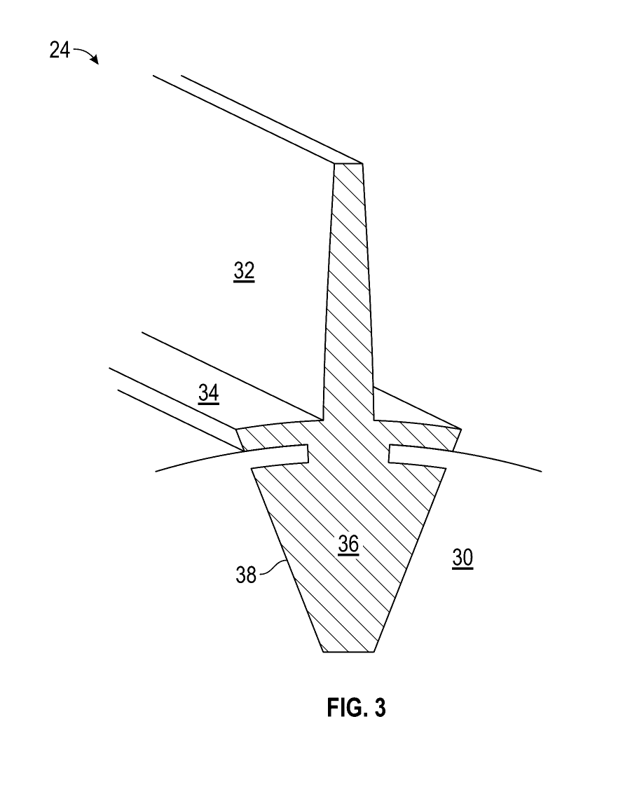

FIG. 2 illustrates a turbine rotor 24 structure in more detail. While the description relates to a turbine rotor 24, it is to be appreciated that the present disclosure may be readily applied to other components of the gas turbine engine 10, for example, a compressor rotor. The turbine rotor 24 includes a turbine disc 28 having a disc rim 30 to which a plurality of radially-extending turbine blades 26 are mounted. Each turbine blade 26 includes an airfoil portion 32 extending from a blade platform 34. As shown in FIG. 3, a blade root 36 extends radially inboard of the blade platform 34 and is inserted into a complimentary slot 38 or other opening in the disc rim 30 to mount the turbine blade 26 to the turbine disc 28. The turbine blade 26 may be anchored in place in the turbine disc 28 by bolts, rivets, or other mechanical fastening arrangements.

Referring again to FIG. 2, the turbine rotor 24 further includes a cover plate 40 located upstream of the disc rim 30 to cover an upstream annular face 42 of the disc rim 30, and the joint between the blade root 36 and slot 38 to prevent leakage of hot gaspath flow therethrough. The cover plate 40 may be a single piece extending circumferentially around the entire turbine rotor 24 or may be segmented into, for example, six, eight or ten circumferential segments. Radially inboard of the disc rim 30, the turbine disc 28 includes a disc arm 44 extending axially upstream of the turbine disc 28. The disc arm 44 includes an inner arm flange 46, which may be used to connect an upstream turbine rotor 24 to the present turbine rotor 24 via bolts or other fasteners extending through the inner arm flange 46.

The disc arm 44 further includes an outer arm flange 48 extending radially outwardly from the disc arm 44. The outer arm flange 48 retains a inboard end of the cover plate 40, in some embodiments via radial overlap between the outer arm flange 48 and the cover plate 40, with the cover plate inboard end 50 located axially downstream of and abutting the outer arm flange 48. The cover plate 40, the disc rim 30, the disc arm 44 and the outer arm flange 48 together enclose and define a rim cavity 52.

It is desired to provide an airflow into the cavity 52 to thermally condition, or cool, the adjacent components the cover plate 40, and the turbine disc 28 to enhance the service life of the components. To that end, one or more airflow openings 54 extend through the disc arm 44. In some embodiments, the airflow openings 54 are circular, but other cross-sectional shapes such as oval, elliptical or other shapes may be utilized. In some embodiments, a plurality of airflow openings 54 is distributed about a circumference of the disc arm 44. In some embodiments, the airflow openings 54 are equally spaced around the circumference.

The airflow openings 54 are sized and configured to allow an airflow 56 from a turbine interior 58, radially inboard of a hot gas path 60, into the cavity 52. The airflow 56 circulates through the cavity 52, exchanging thermal energy with the turbine disc 28 and cover plate 40, thus reducing a temperature of the cover plate 40 and the turbine disc 28.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A rotor assembly for a gas turbine engine, comprising:
a rotor disc having an axially extending rotor disc arm;
a plurality of rotor blades extending radially outwardly from the rotor disc; and
a cover plate disposed at an axial face of the rotor disc and at least partially retained at a rotor disc arm, the rotor disc and cover plate defining a rotor cavity, a plurality of airflow openings extending into the cavity to allow a flow of air into the rotor cavity to thermally condition the rotor disc and the cover plate at the rotor cavity.

2. The rotor assembly of claim 1, wherein the plurality of airflow openings extend through the rotor disc arm.

3. The rotor assembly of claim 1, further comprising an outer arm flange disposed at the rotor arm to retain the cover plate at the rotor disc arm.

4. The rotor assembly of claim 1, wherein the rotor cavity is disposed radially outboard of the rotor disc arm.

5. The rotor assembly of claim 1, wherein the cover plate is disposed radially outboard of the rotor disc arm.

6. The rotor assembly of claim 1, wherein the plurality of rotor arm openings are one or more of circular, oval or elliptically-shaped.

7. The rotor assembly of claim 1, wherein the plurality of rotor arm openings are equally spaced around a circumference of the rotor disc arm.

8. The rotor assembly of claim 1, wherein the rotor disc arm extends in an axially upstream direction from the rotor disc.

9. The rotor assembly of claim 1, wherein the rotor disc is a rotor disc of a turbine rotor.

10. A gas turbine engine, comprising:
a combustor; and
a rotor disposed in fluid communication with the combustor, the rotor including:
a rotor disc having an axially extending rotor disc arm;
a plurality of rotor blades extending radially outwardly from the rotor disc; and
a cover plate disposed at an axial face of the rotor disc and at least partially retained at a rotor disc arm, the rotor disc and cover plate defining a rotor cavity, a plurality of airflow openings extending into the cavity to allow a flow of air into the rotor cavity to thermally condition the rotor disc and the cover plate at the rotor cavity.

11. The gas turbine engine of claim 10, wherein the plurality of airflow openings extend through the rotor disc arm.

12. The gas turbine engine of claim 10, further comprising an outer arm flange disposed at the rotor arm to retain the cover plate at the rotor disc arm.

13. The gas turbine engine of claim 10, wherein the rotor cavity is disposed radially outboard of the rotor disc arm.

14. The gas turbine engine of claim 10, wherein the cover plate is disposed radially outboard of the rotor disc arm.

15. The gas turbine engine of claim 10, wherein the plurality of rotor arm openings are one or more of circular, oval or elliptically-shaped.

16. The gas turbine engine of claim 10, wherein the plurality of rotor arm openings are equally spaced around a circumference of the rotor disc arm.

17. The gas turbine engine of claim 10, wherein the rotor disc arm extends in an axially upstream direction from the rotor disc.

18. The gas turbine engine of claim 10, wherein the rotor is a turbine rotor.

19. A method of thermally conditioning a rotor disc of a gas turbine engine, comprising:
positioning a cover plate at a rotor disc such that a cavity is defined between the cover plate and the rotor disc;
directing an airflow into the cavity through a plurality of airflow openings in the rotor disc; and
thermally conditioning the rotor disc and/or the cover plate at the cavity via a thermal energy exchange between the airflow and the rotor disc and/or the cover plate.

20. The method of claim 19, wherein the plurality of airflow openings are disposed at an axially-extending rotor disc arm of the rotor disc.
